(19) United States
(12) Patent Application Publication
(10) Pub. No.: US 2012/0211310 A1
(43) Pub. Date: Aug. 23, 2012

(54) ELEVATOR SYSTEM AND LOAD BEARING MEMBER FOR SUCH A SYSTEM

(76) Inventors: Danilo Peric, Luzern (CH); Oliver Berner, Sursee (CH); Ernst Ach, Ebikon (CH)

(21) Appl. No.: 13/502,273

(22) PCT Filed: Oct. 6, 2010
(86) PCT No.: PCT/EP2010/064902

§ 371 Date: Apr. 16, 2012

(30) Foreign Application Priority Data
Oct. 14, 2009 (EP) 09173069.7

(51) Int. Cl. B66B 11/08

(52) U.S. Cl. 187/254

(57) ABSTRACT

An elevator system has a suspension member for supporting and/or moving an elevator car and being guided and driven by a traction sheave of a drive unit. The suspension member is a cord or rope that includes a body made of a polymer and at least one tension member made of wires extending in the longitudinal direction of and embedded in the body. A thickest wire in the tension member has a bending stress σb in a range from 350 N/mm² to 900 N/mm² when bending the tension member about a minimum bending radius r, and wherein the bending stress is a function of the elastic modulus E and the diameter δ of the thickest wire, according to the equation σb=(δ*E)/2r, wherein the suspension member is run about a pulley having a minimum diameter D corresponding to no more than two times the minimum bending radius (D≦2r).

### FIELD

The subject of the invention is an elevator system and a load bearing member for moving an elevator car in such an elevator system.

### BACKGROUND

Elevator systems of the type according to the invention usually have an elevator car and at least one counterweight connected to the elevator car and movable in an elevator shaft or along free standing guide devices. To generate movement, the elevator system has at least one drive in each case with at least one driving pulley cooperating via drive means and/or load bearing members with the elevator car and, if appropriate, with the counterweight. The load bearing members carry the elevator car and the counterweight, and the drive means transmit the required drive forces to these. Often, however, the drive means at the same time also assumes the carrying function. For the sake of simplicity, therefore, the load bearing members and/or drive means are designated hereafter simply as load bearing members.

Even very early on in the history of elevators, the demonstrable aim was toward small lightweight motors, and it was recognized that smaller rope diameters make it possible to use smaller driving pulleys and therefore smaller motors (cf. DE 6338 from 1878). The use of flat ropes is also known even at this time (ibid.). The topic in the early stages was also the insufficient traction of steel ropes on cast iron or steel driving pulleys, and therefore the first trials with sheathed driving pulleys and sheathed load bearing members can be dated to the start of the twentieth century (cf. U.S. Pat. No. 1,047,330 from 1912), at that time leather preferably being adopted as sheathing material. When suitable synthetic sheathing material was provided by the polymer industry, elevator builders began in the 1970s to entertain the possibility of polymer sheathed load bearing members (cf. U.S. Pat. No. 1,362,514 from 1974), polyurethane playing an important part as sheathing material from the outset (ibid.).

The behavior of the metallic tension members in the polymeric sheathing is of central importance for the service life of a load bearing member, This has led to various proposals for simple design rules according to which a load bearing member with metallic tension members and with a polymeric sheathing is to be capable of being produced.

For example, EP1555234 discloses a V ribbed belt as the load bearing member of an elevator system with tension members composed of stranded steel wires, the overall cross sectional area of all the tension members being intended to amount to 30% to 40% of the overall cross sectional area of the load bearing member. The tension members are to be manufactured from at least 50 individual wires in each case with as small a diameter as possible. FIG. 5 of EP1555234 illustrates such a tension member with a two ply central cord 1+6+12 and 8 outer cords 1+6, without actual statements of the wire diameters of the individual wires or of the driving pulley being made. A diameter of about 2 mm or less is specified for the tension members as a whole.

EP1640307A also discloses tension members sheathed in a belt like manner with an elastomer as the load bearing member of an elevator, the overall width of the belt like load bearing member cooperating with the driving pulley. Better distribution of the rope pressure to the individual tension members is to be achieved thereby. On the basis of the standards for elevator ropes made from steel, which prescribe a ratio of driving pulley diameter D to wire rope diameter d of D/d≧40, EP1640307A proposes a design of the load bearing members according to the following formula: Pmax=(2F/Dw) with Pmax=maximum rope pressure; F=tractive force; D=diameter of the driving pulley; w=width of the belt. The tension members are in each case manufactured from one single ply central cord 1+6 and 6 single ply outer cords 1+6, the central wires of the cords in each case having a larger diameter than the outer wires surrounding them.

Tension members with cords, the central wires of which have in each case a larger diameter than the outer wires surrounding them, are also disclosed in U.S. Pat. No. 546,185B in connection with elevators, conveyor belts and heavy tires. Here, too, the tension members are to be embedded into a polymer, here especially rubber. Via a diameter ratio of the central wire to the outer wires of between 1.05 and 1.5 being selected, cords or ropes as tension members are to be obtained which allow good penetration by the elastomeric sheathing material. The wires are specified with diameters in the range of 0.15 mm to 1.2 mm, the diameter of the tension members being specified in the range of 3 to 20 mm.

U.S. Pat. No. 4,947,638B also attempts to set up a formula for the design of tension members in elastomeric sheathings which ensures a sufficient penetration of the tension member by elastomeric sheathing material, here, however, the modulus of elasticity of the wires and the ratio of the lengths of lay of the outer cords around the central cord and of the cords in themselves also being taken into account,

As the literature given above shows by way of example, in elevator construction and, in particular, in the region of the cooperation between driving pulley and load bearing member, topics, such as good traction, small driving pulleys and therefore small lightweight motors, the distribution of the forces arising on the tension members of the load bearing members or the connection of metallic tension members to the sheathing material, are repeatedly of interest. There is also a latent need for a simple method/formula making it possible to design the tension members in sheathed load bearing members. Viability with lightweight and space saving components which are simple to produce is often in this case in contradiction to the service life of important elevator components and, in particular, in contradiction to the requirements for a long service life of the load bearing member in the elevator system.

### SUMMARY

An object on which the present invention is based is to provide an elevator system of the type described above which takes into account at least some of these topics and at the same time shows good viability along with a sufficient service life of the load bearing member.

The elevator system comprises at least one pulley, via which a load bearing member (12), which moves at least one elevator car, is guided. Advantageously, the load bearing member at the same time also moves a counterweight. The at least one pulley in the elevator system is a driving pulley which belongs to a drive motor and which is driven in rotation by the latter. The load bearing member guided via the driving pulley is moved by means of traction by the driving pulley and transmits this movement to the car connected to the load bearing member and, if appropriate, the counterweight. Preferably, however, the load bearing member not only transmits the movement of the car and, if need be, to the counterweight, but also carries these. The driving pulley is preferably arranged on a shaft of the drive motor and especially advantageously is produced in one piece with said shaft.

Depending on the suspension ratio 1:1, 2:1 or even higher, the elevator system comprises only the driving pulley (1:1 suspension ratio) or else also various further pulleys, via which the load bearing member is guided. These pulleys may be deflecting pulleys, guide pulleys, car carrying pulleys or counterweight carrying pulleys. For reasons of space, pulleys with small diameters and, with regard to smaller and lighter weight motors, particularly also driving pulleys with small diameters are preferred. The number of pulleys and their diameters depend on the suspension ratio and on the composition of the individual components of an elevator in the elevator shaft. Thus, it may happen that the pulleys in an elevator system have different diameters. In this case, the pulleys may be both larger and smaller than the driving pulley. When pulleys are referred to here, these may not only be of disc shaped design, but they may also be designed in cylindrical form, similar to a shaft. However, their function is the deflection, carrying or driving of the load bearing member irrespective of this question of configuration.

It may be noted here that an elevator shaft does not necessarily mean a closed space, but, most generally, the structure which mostly defines the path of movement of the car and, if appropriate, counterweight by means of what are known as guide rails and in or on which nowadays usually also all the components of the drive are received (elevator without machine room).

The load bearing member guided around the pulleys comprises a body manufactured from a polymer and at least one tension member embedded into the body and extending in the longitudinal direction of the load bearing member. The tension member is manufactured from wires, in particular from steel wires of high strength, and is in the form of a cord or a rope, where at the same time the wires may all have the same thickness and the same diameter. However, it is also possible to use wires of different thickness with different diameters. In order to obtain an elevator system having low costs for maintaining the load bearing member, a load bearing member is selected in which the bending stress σb of the wire having the largest wire diameter δ in the tension member lies in a range of between σb=350 N/mm² to 900 N/mm² when it runs over a pulley having the smallest pulley diameter D in the planned elevator system. If the bending stresses are selected for the thickest wire in this stress range, the position of the thickest wire in the tension member is no longer of such elementary importance as has been assumed hitherto. That is to say, in the case of stresses in this range, it is possible to use the thickest wire no longer in the center of the tension member, as hitherto, but instead wire configurations may also be selected in which a wire having the largest diameter is present, for example, in an outer wire ply or cord ply.

The bending stress σb of the thickest wire in a tension member of an elevator load bearing member is obtained approximately as a function of the smallest pulley diameter D via which the load bearing member is guided, of the modulus of elasticity E (also referred to briefly as E modulus) of the thickest wire and of its wire diameter δ according to the following equation: σb=(δ*E)/D. With this relationship being taken into account, the composition of the elevator, with its possibly different pulley diameters, and the load bearing member, with its at least one tension member and with its sheathing, can be coordinated with one another.

If the bending stress σb which is induced, when the load bearing member runs over a pulley having the smallest pulley diameter D, in that wire of the tension member which has the largest wire diameter is selected in the range of between 450 N/mm² and 750 N/mm², the service life of the tension member is increased. The best results in terms of service life and viability are achieved with load bearing members, the tension members of which experience in their thickest wires a bending stress σb in the range of σb=490 N/mm² and 660 N/mm² when the load bearing member runs over a pulley having the smallest pulley diameter D.

The statements made above apply particularly to the customary steel wire types, the E moduli of which lie between 140 kN/mm² and 230 kN/mm²; and, in particular, for wires made from stainless steels with E moduli of between 150 kN/mm² and 160 kN/mm² and from high strength alloyed steels with E moduli of between 160 kN/mm² and 230 kN/mm².

For steel wires with a mean modulus of elasticity of about 190 kN/mm² to about 210 kN/mm² for the wires having the largest wire diameter D in the tension member of a load bearing member, very good values for the service life, along with sufficient viability, have been obtained when the ratio of the pulley diameter D of the smallest pulley in the elevator system to the wire diameter δ of the thickest wire in the tension member lies in the range of D/δ 200 to 600, preferably in the range of D/δ=300 to 500.

An above described elevator system can be configured especially viably when the pulley having the smallest pulley diameter D is the driving pulley, since a small lightweight motor can then be used. If all the pulleys are as small as the driving pulley, the space requirement for these pulleys is also small, which admittedly may lower the service life of the load bearing member.

If the load bearing member comprises more than one tension member (18) extending in the longitudinal direction of the load bearing member (12), and these tension members are arranged in one plane next to one another and so as to be spaced apart from one another, as seen in the width of the load bearing member, then, in general, pulleys with smaller pulley diameters and a smaller lighter weight motor can be used in the elevator system than when load bearing members of the same carrying capacity are employed which have only one tension member or a plurality of tension members one above the other in various “plies”. Space and costs can thus be saved.

If the load bearing member is provided an its traction side facing the driving pulley with a plurality of ribs running parallel in the longitudinal direction of the load bearing member and at the same time the driving pulley is provided in its periphery with grooves running in the circumferential direction and matching with the ribs of the load bearing member, the load bearing member can be guided more effectively in the driving pulley.

If the grooves of the driving pulley are provided, moreover, with a lower lying groove bottom, so that a wedge effect is obtained when the grooves cooperate with the ribs, traction is also markedly increased and can be set as a function of the selected wedge angle of the ribs or grooves.

In a particular embodiment of the elevator system, the grooves of the driving pulley are of wedge shaped form, and in this case, in particular, they have a triangular or trapezoidal cross section. The wedge shape arises in each groove due to two side walls, also called groove flanks, which run toward one another at a flank angle β′. Especially good guidance and traction properties are obtained in the case of a flank angle β′ of 81° to 120°, even better ones in the case of a flank angle β′ of 83° to 105°, even better ones in the range of 85° to 95° and the best ones at a flank angle β′ of 90°.

For good guidance of the load bearing member in the elevator system, in addition to the driving pulley, other pulleys may also be provided with corresponding grooves which match with the ribs of the load bearing member on the traction side of the latter.

Also, if the load bearing member is guided with counterbending, the load bearing member may advantageously be provided, on a rear side lying opposite its traction side, with a guide rib which matches with a guide groove in a guide, carrying or deflecting pulley.

In order to obtain a load bearing member for the movement and, where applicable, carrying of an elevator car, said load bearing member having good traction properties and a high carrying capacity, a load bearing member is provided which comprises a body manufactured from a polymer and at least one tension member embedded in the body and extending in the longitudinal direction of the load bearing member. The tension member is manufactured from wires and is in the form of a cord or rope. So that the load bearing member has a long service life in the elevator system, the tension member for the load bearing member is designed such that the bending stress σb of the wire having the largest wire diameter δ in the tension member lies in a range of between σb=350 N/mm² to 900 N/mm² in the event of bending about a smallest bending radius r. The bending stress is in this case obtained as a function of the modulus of elasticity E and of the diameter δ of the thickest wire and as a function of the smallest bending radius r provided.

The mutual dependencies can be illustrated mathematically in simplified form. The bending stress σb is obtained according to the following equation: σb=(δ*E)/2r. The smallest bending radius r provided is obtained, in consultation with the elevator builder, from the diameter D of the smallest pulley provided in the elevator system as: r=D/2.

The body of the load bearing member is produced from a polymer, preferably an elastomer. The hardness of elastomers can be set, and, in addition to this necessary hardness, they at the same time afford sufficiently high wear resistance and elasticity. Temperature and weathering resistance and further properties of elastomers also increase the service life of the load bearing member. If, moreover, the elastomer is a thermoplastic elastomer, the load bearing member can be produced, together with its body and with the embedded tension members, in an especially simple and cost-effective way, for example by extrusion.

Depending on the required friction factor between the traction side of the load bearing member and the driving pulley or rear side of the load bearing member and another pulley, the load bearing member may be constructed from a single elastomer or from various elastomers, for example in layers, with different properties.

Polyurethane, in particular thermoplastic, ether-based polyurethane, polyamide, natural and synthetic rubber, such as, in particular, NBR, HNBR, EPM and EPDM, are especially suitable as material for the body of the load bearing member. Chloroprene may also be used in the body, particularly as an adhesive.

To take into account special properties, it is also possible to provide the side having the traction side and/or the rear side of the load bearing member with a coating. This coating may be applied, for example, by flocking or extrusion or else be sprayed on, laminated on or glued on. It may preferably also be a woven fabric made from natural fibers, such as, for example, hemp or cotton, or from synthetic fibers, such as, for example, nylon, polyester, PVC, PTFE, PAN, polyamide or a mixture of two or more of these fiber types.

In a first embodiment, the load bearing member, when bent about a smallest bending radius r in the thickest wire of its at least one tension member having the largest wire diameter δ, has a bending stress σb which lies in the range of σb=450 N/mm² to 750 N/mm² and preferably in the range of σb=490 N/mm² to 660 N/mm².

In a further embodiment of the load bearing member, the wire with the largest wire diameter δ has a modulus of elasticity of about 210,000 N/mm². For this embodiment, an especially long service life of the load bearing member, along with very good viability, is obtained when the ratio of the smallest bending radius r to the wire diameter δ of the thickest wire in the tension member lies in the range of 2r/δ=200 to 600, and even longer when it lies in the range of 2r/δ=300 to 500.

In a further embodiment, the load bearing member has, in addition to at least one of the above-described properties, a tension member in which the cords or wires at least in an outermost wire ply or cord ply are spaced at least 0.03 mm apart from one another.

The spacing is greater, the higher the viscosity of the polymer embedding the tension member when the tension member is embedded.

In a further embodiment, as seen from the outside inward, the more cord plies or wire plies in this form are spaced apart from one another, the more cord plies and/or wire plies there are overall.

In a further embodiment, both of these apply. This means that, at least in one cord ply, both the cords and the outer wires in these outer cords are spaced at least 0.03 mm apart from one another.

By virtue of this measure or these measures, a good mechanical connection of the tension member to the material of the load bearing member body is ensured, thus further increasing the service life of the load bearing member. It may be noted here that spacing apart may be provided in the circumferential direction and/or in the radial direction.

In a particular embodiment, the load bearing member has more than one tension member extending in the longitudinal direction of the load bearing member (12), the tension members being arranged in one plane next to one another and so as to be spaced apart from one another, as seen in the width of the load bearing member. Thus, the load which has to be absorbed by the load bearing member is distributed to the plurality of tension members of smaller diameter, with the result that the smallest bending radius r selected for this load bearing member can be smaller. Moreover, by the tension members being distributed in only one plane, the bending stress and the surface pressure can be distributed relatively uniformly to all the tension members, thus increasing the service life and ensuring a quieter run of the load bearing member over the pulleys.

In further embodiments, the load bearing member comprises at least one tension member which is designed as a cord in a seal configuration with a core composed of 3 wires, each with a diameter a, and with two wire plies surrounding the core and having wire diameters b (1st wire ply) and wire diameters c (2nd wire ply). An especially advantageous configuration of this type is (3a−9b−15c), in which a, b, c are wire diameters which, depending on the configuration, are all different, all the same or only partly the same. The numerals in front of the wire diameters indicate the number of wires having this diameter. The brackets indicate that it is a cord, the numeral/letter combinations, read from left to right, giving the configuration of the wires from the cord center outward. The dashes between the numeral/letter combinations separate the core of the cord from the following ply and this ply from the next following numeral/letter combinations which are linked by a hyphen, but stand in common brackets, that is to say belong to different plies of a cord.

In a further embodiment, the at least one tension member of the load bearing member has a wire configuration (1f−6e−6d+6c)W+n*(1b+6a), where n is a whole number between 5 and 10 and the smallest bending radius r is at least r≧30 mm. a, b, c, d, e, f are wire diameters which, depending on the configuration, are all different, all the same or only partly the same, and W stands for a Warrington configuration, such as is shown, for example, in DIN EN 12385-2: 2002 under 3.2.9 FIG. 7. As is clear from the nomenclature of the wire configuration, this is a core cord in a Warrington configuration which comprises a core wire with diameter f, a first wire ply with 6 wires of diameter e and a second wire ply in each case with 6 wires of diameters d and c (numeral/letter combinations linked by “+”). This core cord is surrounded by a number of cords n which in each case comprise a core wire of diameter b and a first wire ply with 6 wires of diameter a.

in another embodiment, the at least one tension member of the load bearing member has a wire configuration (3d+7c)+n*(3b+8a), where n is a whole number between 5 and 10 and where the smallest bending radius r is at least r≧50 mm. a, b, c, d are wire diameters which, depending on the configuration, are all different, all the same or only partly the same.

In another embodiment again, the load bearing member comprises at least one tension member with a wire configuration (3f+3e+6d)W+n*(3c+3b+6a)W, where n is a whole number between 5 and 10 and where the smallest bending radius r is at least r 40 mm. a, b, c, d, e, f are wire diameters which are all different, all the same or only partly the same and W stands for a Warrington configuration.

In yet another embodiment, the load bearing member comprises at least one tension member with a wire configuration (1e+6d+12c)+n*(1b+6a)W, where n is a whole number between 5 and 10 and where the smallest bending radius r is at least r≧35 mm. a, b, c, d, e are wire diameters which, depending on the configuration, are all different, all the same or only partly the same. W stands for a Warrington configuration.

The abovementioned embodiments of the load bearing member have especially good torque properties and good rope stability when the tension members are laid SZS or ZSZ (cf. DIN EN 1235-2:2002 under “3.8 lay directions and lay types”), that is to say when the tension members are laid left-right-left or right-left-right. The torque properties are even better when in each case one, two or three SZS-laid tension members alternate in each case with the same number of ZSZ-laid tension members and all the tension members should be embedded in one plane next to one another in the polymer sheath. The number of ZSZ-laid and SZS-laid tension members should be identical over the entire load bearing member.

In a further embodiment, the load bearing member has a plurality of the above-described tension members, preferably all the tension members having the same wire configuration so that the carrying strength, tension conditions and stretch properties of all the tension members are the same.

In another embodiment, the load bearing member comprises a plurality of tension members with different wire configurations, the configurations being adapted with their specific properties to the position in the load bearing member (central or on the outside). This may be advantageous when the stresses on the tension members exhibit major deviations as a function of position in spite of arrangement in one plane.

In a particular embodiment, the load bearing member is configured on one side as a traction side which has a plurality of ribs running parallel in the longitudinal direction of the load bearing member. In this case, it is advantageous if the load bearing member also has more than one tension member extending in the longitudinal direction of the load bearing member.

In a further embodiment, the load bearing member is provided on the traction side with a plurality of ribs which run parallel in the longitudinal direction of the load bearing member and which have a wedge-shaped, in particular triangular or trapezoidal cross section with a flank angle β in the range of 81° to 120°, preferably of 83° to 105° or 85° to 95° and at best of 90°. The advantages correspond to those which have already been referred to with regard to a driving pulley having similarly configured grooves.

The stress and load upon the tension members of a load bearing member can be distributed especially uniformly when each rib is assigned two tension members on the traction side of a load bearing member. It is especially advantageous in this case if the tension members are arranged in each case in the region of the vertical projection P of a flank of the rib. In particular, the tension members should be arranged centrally above the projection of the flank.

It is likewise highly advantageous if each rib of the load bearing member is assigned exactly one tension member which is arranged centrally with respect to the two flanks of the rib. Such a configuration also allows a highly uniform distribution of the forces to all the tension members of the load bearing member. Moreover, with the rib size being the same, tension members with a larger diameter can be used, without the running properties being adversely affected.

In a further embodiment, the load bearing member has exactly two ribs on the traction side. Such a load bearing member affords, in addition to the advantages which a V-ribbed belt has, the advantage that the number of load bearing members can be coordinated very accurately with the load to be carried in the elevator. In a particular embodiment, this load bearing member has a guide rib on its rear side lying opposite the traction side, in order, in the case of counter bending, to be guided via a correspondingly designed pulley with a guide groove, without additional measures for lateral guidance of the load bearing member having to be taken.

In a further particular embodiment, such a load bearing member may also be higher than it is wide, such that higher internal stress occurs in the load bearing member body during bending, thus, in turn, reducing the risk of jamming with the load bearing member in a pulley provided with grooves.

As may already be gathered from the previous description, the features of the various embodiments may be combined with one another and are not restricted to the examples in connection with which they are described. This also becomes clear from the following explanations of the invention by means of the accompanying diagrammatic drawings. The exemplary embodiments illustrated in the respective drawings show in each case specific features in combination with one another. This does not mean, however, that they can expediently be used only in the combination shown. On the contrary, they can just as well be combined expediently with features of other examples shown or described.

### DESCRIPTION OF THE DRAWINGS

In the exemplary and purely diagrammatic figures:

FIG. 1 shows a section, parallel to an elevator car front, through an elevator system according to the invention;

FIG. 2a shows a perspective view of a rib side of a first exemplary embodiment of a load bearing member according to the invention in the form of a V-ribbed belt;

FIG. 2b shows a cross-sectional view of the load bearing member according to FIG. 2 with various examples of possible rib configurations;

FIG. 3a shows a perspective view of a second exemplary embodiment of a load bearing member according to the invention in a form of a flat belt;

FIG. 3b shows, enlarged, a detail of the flat belt from FIG. 3a;

FIG. 4a shows a section parallel to the axis of rotation of a driving pulley of an elevator system and through a further exemplary embodiment of a load bearing member running over it;

FIG. 4b shows a section through yet a further exemplary embodiment of a load bearing member of the elevator system perpendicularly to its tension members;

FIG. 5 shows a section, similar to that in FIG. 4b, through yet another exemplary embodiment of a load bearing member of the elevator system;

FIG. 6 shows a section, similar to that in FIG. 4b, through yet another exemplary embodiment of a load bearing member of the elevator system;

FIG. 7 shows a section, similar to that in FIG. 4b, through yet a further exemplary embodiment of a load bearing member of the elevator system;

FIG. 8 shows a cross section through a first exemplary embodiment of a steel wire tension member;

FIG. 9 shows a cross section through a second exemplary embodiment of a steel wire tension member;

FIG. 10 shows a cross section through a third exemplary embodiment of a steel wire tension member; and

FIG. 11 shows a cross section through a fourth exemplary embodiment of a steel wire tension member.

### DETAILED DESCRIPTION OF THE INVENTION

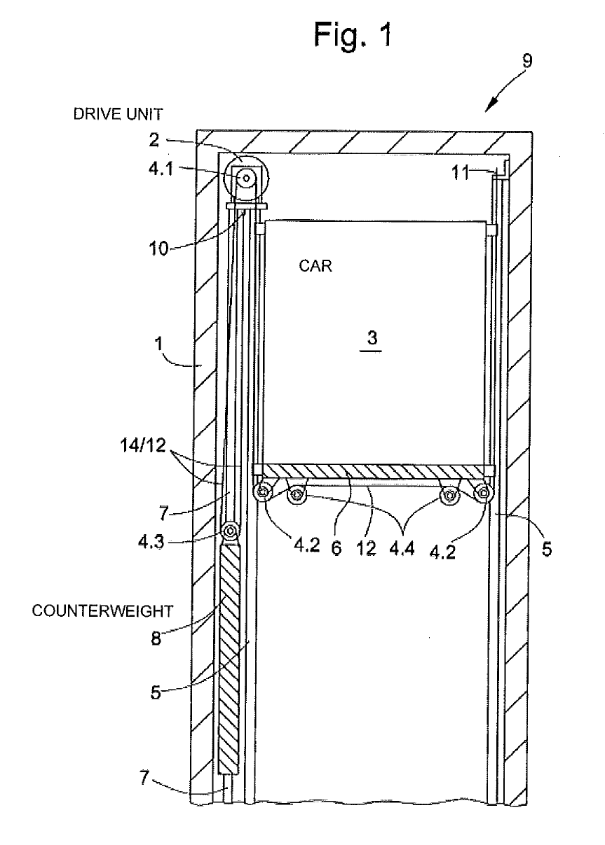

FIG. 1 shows a section through an elevator system 9 according to the invention in an elevator shaft 1. What are illustrated are essentially a drive unit 2 arranged at the top in the elevator shaft 1 and having a driving pulley 4.1 and also an elevator car 3 guided on car guide rails 5 and having car carrying pulleys 4.2 mounted beneath the car floor 6. Moreover, there is a counterweight 8 guided on counterweight guide rails 7 and having a counterweight carrying pulley 4.3 and a load bearing member 12 which carries the elevator car 3 and the counterweight 8 and at the same time transmits the drive force from the driving pulley 4.1 of the drive unit 2 to the elevator car 3 and the counterweight 8.

The load bearing member 12 has at least two elements which are likewise designated hereafter simply as load bearing members 12, although these perform not only a carrying function, but also a driving function. Only one load bearing member 12 is illustrated. However, it is clear to an elevator expert that, for safety reasons, there are usually at least two load bearing members 12 in an elevator system. Depending on the car weight, and on the suspension ratio and carrying force of the load bearing members 12, these can be used parallel to one another and so as to run in the same direction or else in another configuration with respect to one another. Two or more load bearing members 12 running parallel and in the same direction may be combined into a load bearing member string, in which case either this one load bearing member string or else a plurality of load bearing member strings may be provided in an elevator system. These, too, may be arranged again parallel and so as to run in the same direction or in any other desired configuration in the elevator system.

Contrary to the 2:1 suspension ratio shown in FIG. 1, elevator systems with 1:1, 4:1 or any other desired suspension ratios can also be configured as elevator systems according to the invention. Also, the drive with the driving pulley 4.1 does not necessarily have to be arranged at the top in the elevator shaft, but may also be arranged, for example, in the shaft bottom or in the shaft in a gap next to the path of movement of the car and of an adjacent shaft wall, and, in particular, also above a shaft door. The element designated here as a load bearing member 12 may also be used as a straightforward load bearing member or as a straightforward drive means.

In the exemplary embodiment, shown in FIG. 1, of an elevator system 9 according to the invention, the load bearing member 12 is fastened at one of its ends, beneath the driving pulley 4.1, to a first load bearing member fixed point 10. It extends from the latter downward as far as a counterweight carrying pulley 4.3 arranged on the counterweight 8, loops around said counterweight carrying pulley and extends from this to the driving pulley 4.1. It loops around the driving pulley 4.1, in this case at about 180°, and runs downward along the counterweight-side car wall. It then loops underneath the car 3, at the same time looping on each of the two sides of the elevator car 3 around a car carrying pulley 4.2, mounted beneath the elevator car 3, in each case at approximately 90°, and runs upward along the car wall facing away from the counterweight 8 to a second load bearing member fixed point 11. In order to ensure better guidance of the load bearing member 12 through and under the car floor 6, guide pulleys 4.4 are provided between the two car carrying pulleys 4.2. This is especially expedient in the case of long distances between the car carrying pulleys 4.2.

In the example, shown in FIG. 1, of an elevator system 9 according to the invention, a load bearing member 12 according to the invention with tension members according to the invention is used and is guided via a driving pulley 4.1 coordinated with the load bearing member 12 according to the invention. The selected driving pulley 4.1 of the elevator system 9 according to the invention can thereby be very small, thus reducing the space requirement and making it possible to employ a smaller lighter-weight drive. The plane with the driving pulley 4.1 is arranged at right angles to the counterweight-side car wall with its vertical projection lying outside the vertical projection of the elevator car 3. Owing to the small driving pulley diameter, it is possible to keep the gap very small between the car wall and the shaft wall, lying opposite it, of the elevator shaft 1. On account of the small size and low weight of the drive unit 2, it is possible to mount and support the drive unit 2 on one or more of the guide rails 5, 7. It is thus possible to introduce the overall dynamic and static loads of the car and of the motor and also vibrations and noises of the running motor through the guide rails 5, 7 into the shaft bottom instead of into a shaft wall.

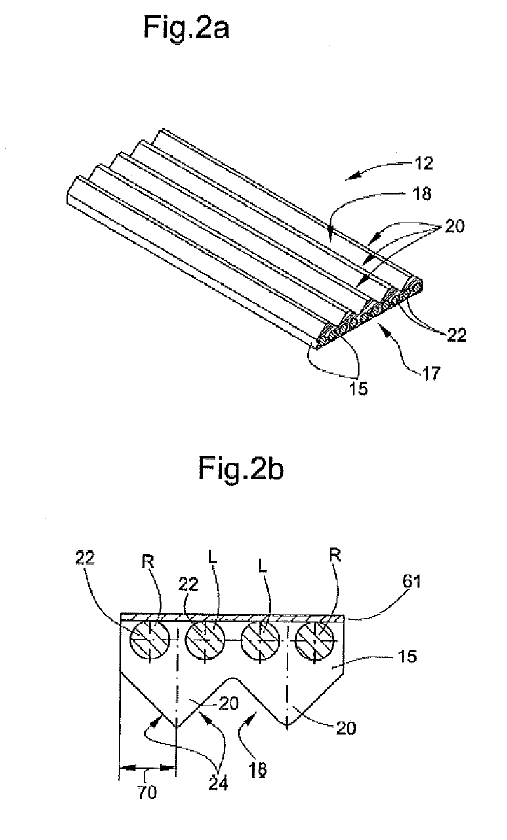

FIG. 2a shows in perspective a portion of a preferred exemplary embodiment of a load bearing member 12 according to the invention. In this exemplary embodiment, the load bearing member 12 is designed as a V-ribbed belt with a flat rear side 17 and with a traction side 18 provided with ribs 20. What can be seen are its belt body 15 with wedge-shaped ribs 20 and tension members 22 according to the invention which are embedded in the body 15 and are arranged in one plane next to one another and so as to be spaced apart from one another. As illustrated in FIG. 2b, it is possible to configure the ribs 20, as seen in cross section, instead of trapezoidally (FIG. 2a), also triangularly (FIG. 2b on the left) or triangularly with a rounded tip (FIG. 2b on the right). Two tension members 22 according to the invention are provided for each rib 20 of the load bearing member 12 configured as V-ribbed belt and are arranged in each case centrally above a projected area 70 of a flank 24 of the rib 20 of the load bearing member. In each case a tension member 22 with right-hand twist in terms of its overall torque, designated by “R”, and a tension member 22 with left-hand twist in terms of its overall torque, designated by “L”, are provided for each rib 20 of the load bearing member 12. The torques of the individual tension members 22 should thus cancel one another out and the load bearing member 12 should be free of torque.

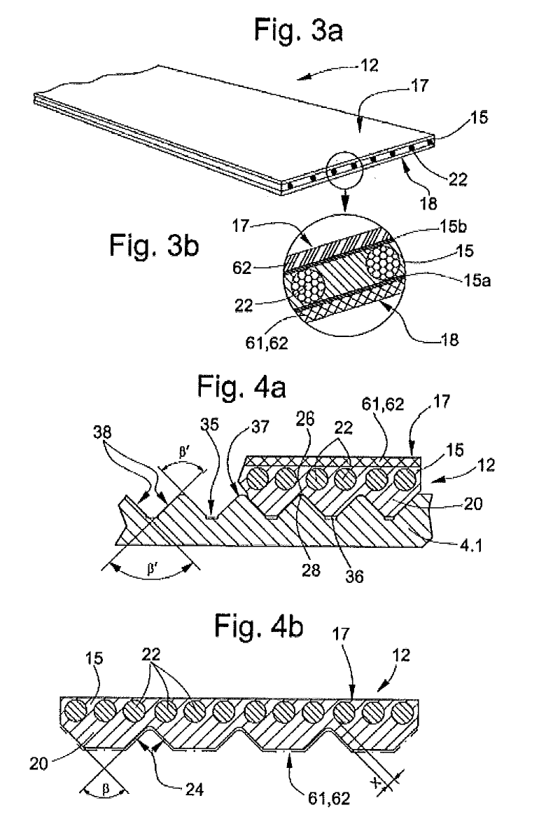

A further example of a load bearing member according to the invention is shown in FIGS. 3a and 3b. This load bearing member is configured both on its traction side 18 and on its rear side 17 with a planar surface. As in the previous example, tension members 22 according to the invention are arranged in one plane next to one another. They are embedded in uniform spacings with respect to one another in the polymer of the body 15 of the load bearing member 12 and are selected in terms of their number and torques such that their torques cancel one another out over the entire load bearing member 12. The material of the body 15 is arranged between and around each tension member 22. In order to satisfy the specific requirements regarding the traction side 18 and the opposite rear side 17 (for example, different hardness, wear resistance, coefficients of friction), the load bearing member 12 illustrated is of multilayer construction. Located on the traction side, above the polymer of the basic body 15, is a harder carrying layer 15a which is provided with a coating 61 composed of wear-resistant woven fabric 62. The hard carrying layer 15a is advantageous in respect of uniform force distribution in the load bearing member 12 when the latter runs over the driving pulley 4.1. The wear-resistant coating 61 with the woven fabric 62 protects against abrasion. Provided on the rear side of the actual body 15 with the load bearing member 12 is a covering layer 15b which is softer, at least in relation to the carrying layer 15a, and which allows quiet running over the pulleys 4.2, 4.3, 4.4 of the elevator system 9 under counter bending, and a coating 61 which contains, for example, polytetrafluoroethylene reduces friction when the load bearing member 12 runs over these pulleys 4.2, 4.3, 4.4 under counter bending, thus further improving quiet low-wear sliding and rolling over these pulleys. The thickness of individual layers is not shown true to scale and must be selected according to the requirements.

The tension members 22 in the load bearing member 12 according to the invention are produced by stranding from steel wires of high strength (strength values in the range of 1770 N/mm² to approximately 3000 N/mm²). Stranding is in this case organized such that, in the event of bending of a load bearing member 12 provided with such a tension member 22 over a smallest bending radius r, a bending stress σb in the thickest wire having the largest wire diameter δ in the tension member 22 lies in the range of 300 N/mm² and 900 N/mm². According to the invention, to use this load bearing member 12 in the elevator system, the smallest bending radius r is equal to half the diameter of the smallest pulley in the elevator system, that is to say r=D/2.

According to the invention, the design of the load bearing member 12 or of the tension members 22 in the load bearing member 12 takes place such that, if the load bearing member 12 runs with a tension member 22 over a smallest pulley having a smallest pulley diameter D in the elevator system 9, the bending stress σb for the thickest wire of the tension member 22 is obtained, as a function of its modulus of elasticity E and of its diameter δ, according to the following equation: σb=(δ*E)IDk or σb=(δ*E)/2r.

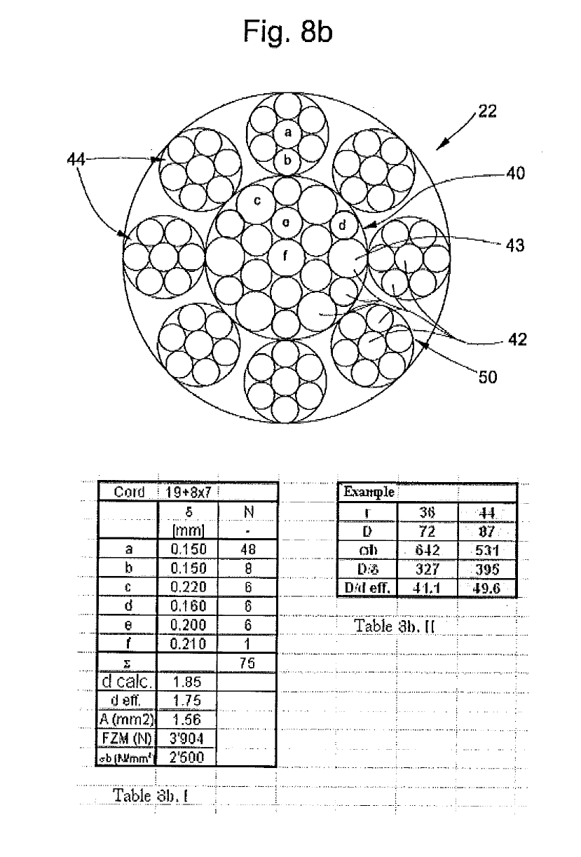

Examples of tension members 22 according to the invention are illustrated in FIGS. 7 to 12. The accompanying tables “I” give examples of possible wire diameters δ of individual wire types in mm under “Cord” downward with a, b, c, d, e and f. The number N of wires of the individual wire types a, b, c, d, e, f present in the tension member 22 are given in mm on the right next to the wire diameter value; underneath is the sum of all the wires 42 in the tension member 22. The calculated diameter d of the tension member 22 is given in mm on the right next to the heading “d calc.”. Underneath, the diameter d eff., averaged for measurements, of the tension member 22 is given in mm next to the heading “d eff.”. Underneath this, the cross-sectional area of the tension member 22 is given in mm² on the right next to the heading “A (mm²)”. The accompanying table II gives under the “examples” in each case for different bending radii r or pulley diameters D examples of the bending stress σb for the thickest wire 43 in the tension member 22, the ratio of the pulley diameter D to the diameter δ of the thickest wire 43 “D/δ” and the ratio of the pulley diameter D to the effective tension member diameter “D/d eff”.

FIG. 7 illustrates a tension member 22 which comprises, according to the standardized nomenclature (cf. DIN EN 1235-2:2002 (D)), a central cord 40 with overall 19 individual wires 42 in a seal configuration (1+6+12) with a central wire e of a first inner wire ply 46 around the central wire e with wires d and of a second outer wire ply 48 with wires c. This gives rise for the central cord 40 to a configuration (1e+6d+12c). The tension member 22 comprises, further, a first cord ply 50 with 8 outer cords 44 which have in each case a central wire b and 6 outer wires a, that is to say overall a configuration 8×(1b+6a). This gives rise to a tension member 22, also called a “Cord” in the accompanying table 7, with a simplified nomenclature 19+8×7.

The configuration, shown in FIG. 7, of the tension member 22 has its thickest wire 43 with the largest diameter δ=e in the center as the central wire of the central cord 40, With a smallest bending radius of 36 mm or with a smallest pulley diameter in an elevator system 9 of 72 mm, this results for this thickest wire 43 in a bending stress σb of σb=554 N/mm², in the ratio of pulley diameter D to wire diameter δ of the thickest wire 43 D/δ=379 and to the ratio of pulley diameter D to the effective diameter d eff of the tension member 22 D/d eff=41.5. For a somewhat larger radius r or pulley diameter D of r=44 mm and D=87 mm, this results in: σb=459 N/mm², D/δ=458 and D/d eff=50.

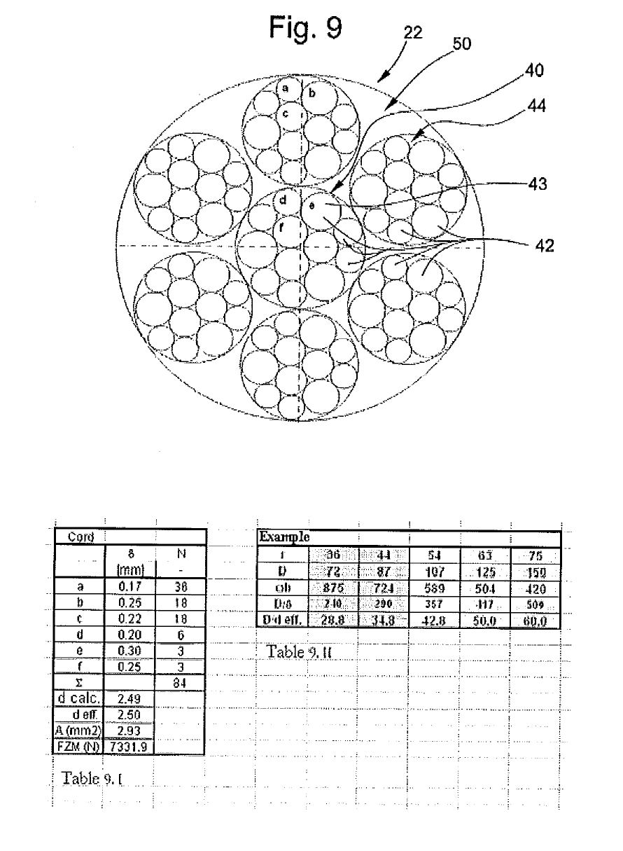

In the embodiments shown in FIGS. 8a and 8b, the tension member 22 has a wire configuration (1f−6e−6d+6c)W+n*(1b+6a), n being a whole number between 5 and 10 and the smallest bending radius r being at least r≧32 mm. FIG. 8a shows a configuration in which n=9, the central cord 40 has a Warrington configuration (1×f−6×e−6×d+6×c) or, written with the diameters of the individual wire types in mm, (1×210−6×200−6×160+6×220), and the 9 outer cords 44 have in each case a central wire with a wire diameter δ: b=140 mm and 6 outer wires with an identical wire diameter δ: a=140 mm, thus resulting overall in a Cord 19+9×7 (see table 8a.I).

The second exemplary embodiment of this configuration in FIG. 8b has the same central cord 40 with the same Warrington set up (1×f 6×e 6×d+6×d) and the same wire diameters δ=210 mm, e=200 mm, d=160 mm, c=220 mm. In this embodiment, however, instead of the 9 outer cords 44 with seven individual wires 42, 8 outer cords 44 of the configuration (1b+6a) are provided. The wire diameters δ of the individual wires 42 are adapted correspondingly here: b=150 mm, a=150 mm. As is clear from the accompanying tables (8b.I and 8b.II), the bending stress σb in the thickest wires 43 of diameter δ=c and the ratios of D/δ and Did eff. are dependent respectively on the pulley diameter D and on the bending radius r, but, between the two embodiments 8a and 8b, the bending stress σb for the thickest wire c and the ratio of D/δ do not change. This seems to be different for the determined diameters d calc and d eff, the cross sectional area A and, above all, the carrying capacity FZM of the tension member 22 over the number of wires N. The tension member 22 from example 8a has here, throughout, lower values than the tension member 22 from the example 8b.

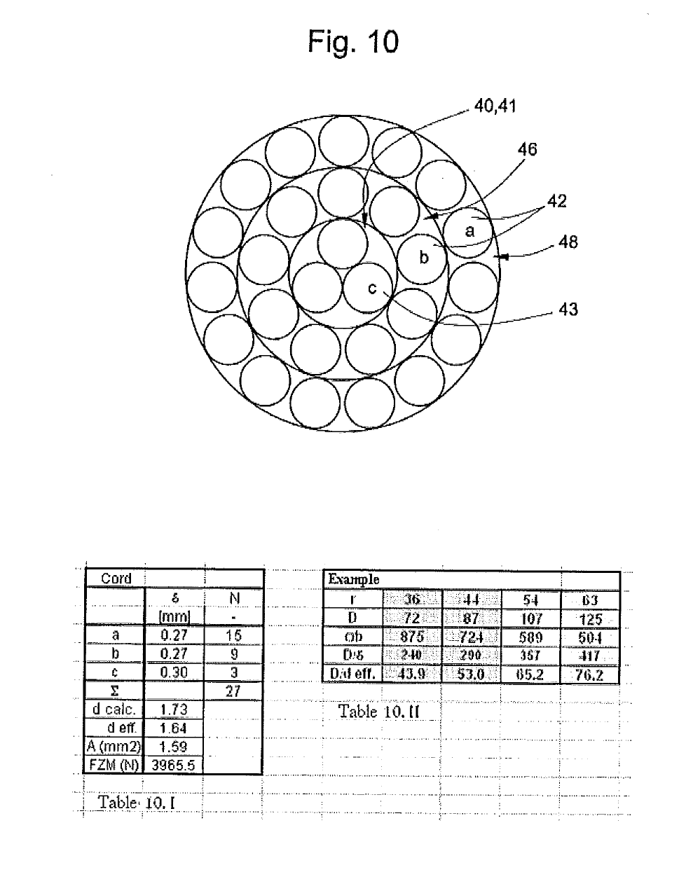

The embodiment in FIG. 9 shows a tension member 22 with a basic wire configuration (3f+3e+3d)+n*(3c+3b+3a), n being a whole number between 5 and 10 and the smallest bending radius r being at least r≧30 mm. What is illustrated in concrete terms is a configuration with n=6; a=0.17 mm, b=0.25 mm, c=0.22 mm, d=0.20 mm, e=030 mm, f=0.25 mm. The thickest wire 43 having the largest wire diameter δ is the wire of diameter δ=e=0.30 mm. It belongs to the central cord 40. In the event of bends over the smallest bending radii r between 30 mm and 75 mm, which corresponds to pulley diameters D of 72 mm to 150 mm (cf. table 9.II), the bending stresses σb for the thickest wire 43 lie in the range of σb=875 N/mm² to 420 N/mm². The overall diameter d of the tension member 22 is about 2.5 mm, a carrying capacity FZM over all the wires N of approximately 7330 N/mm² being achieved.

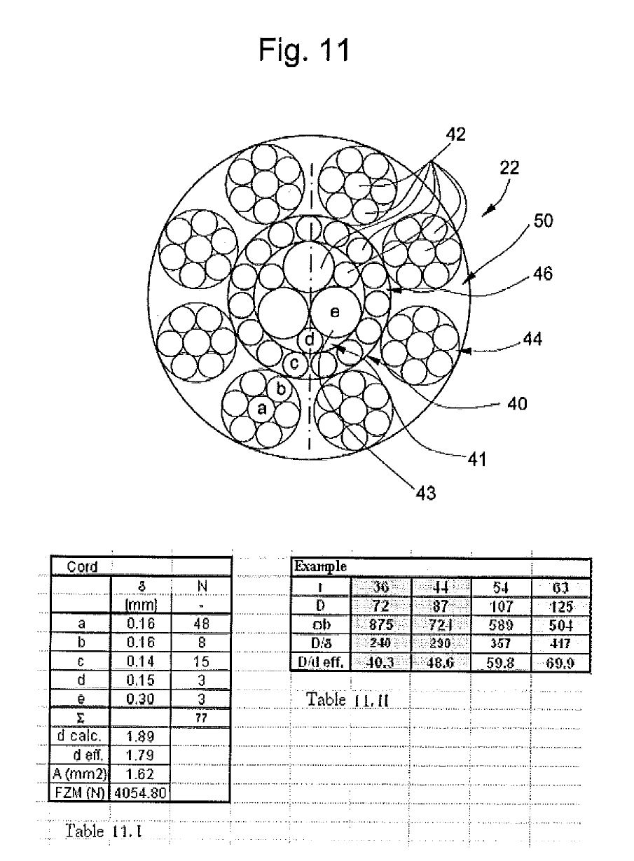

FIG. 10 shows an embodiment of a tension member 22 according to the invention for a load bearing member 12 according to the invention, which is designed as a cord with a core 41 composed of 3 wires, each of diameter a, and with two wire plies 46, 48 surrounding the core and having wire diameters b (1st wire ply 46) and wire diameters c (2nd wire ply 48), that is to say a configuration 3a−9b−15c). In the case of wire diameters δ of a=0.27 mm; b=0.27 mm and c=0.30 mm, the thickest wires 43 in the tension member 22 are the wires of diameter δ=c which form the core 41 of this tension member 22. Table 10.II gives the bending stresses σb for these thickest wires 43 of diameter δ=c when a load bearing member 12 having such a tension member 22 according to the invention is guided and bent with different bending radii r or over pulleys of different size with pulley diameters D. Moreover, the ratios “Did eff.” and “D/δ” are given. As is clear from table 10.II, with bending radii of r=36 mm or calculated in terms of an elevator with pulley diameters D=72 mm, the bending stress σb is σb=875 N/mm²; the ratio of D/δ=240.

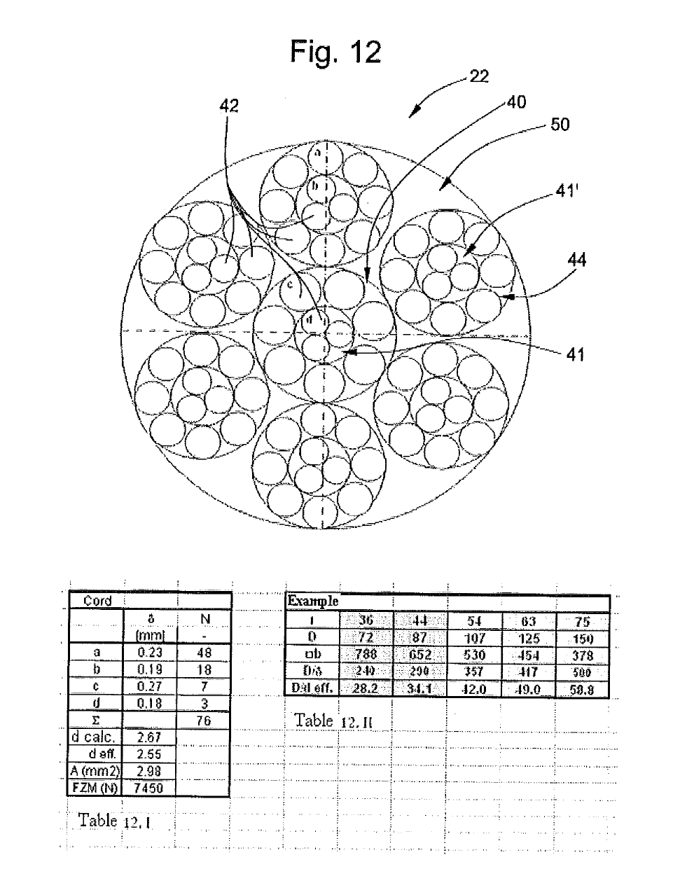

FIG. 11 shows an embodiment of a tension member 22 with a central cord 40 according to (3e+3d−15c) and 8 outer cords 44 according to (1b+6a), the central cord 40 having a core 41 with 3 central wires of diameter e and three fillers of diameter D and also a wire ply 46 with 15 wires of diameter c. The diameter D of the tension member is about 1.8 to 1.9 mm. Further values for this configuration may be gathered from tables 11.I and 11.II.

FIG. 12 shows yet another embodiment of a tension member 22 with a basic wire configuration (3d+7c)+n*(3b+8a) and with n being equal to a whole number between 5 and 10. Here, n is actually equal to 6 (n=6) and the smallest bending radius r is ≧32 mm. The diameter d of the tension member 22 is about 2.5 mm, the bending stress σb for the thickest wire 43 having the largest wire diameter δ (wire of diameter c=0.27 mm) amounts in the case of bending radii r of between 36 mm and 75 mm, thus corresponding to pulley diameters D of 72 mm to 150 mm (cf. table 12.II), to a value in the range of σb=788 N/mm² to 378 N/mm². The overall diameter of the tension member 22 is about 2.5 mm, a carrying capacity FZM over all the wires N of approximately 7450 N/mm² being achieved. Further values for this configuration can be gathered from tables 12.I and 12.II.

The abovementioned embodiments of the tension member 22 have especially good torque properties and good rope stability when these are SZS or ZSZ laid (cf. DIN EN 1235 2:2002 under “3.8 lay directions and lay types”), that is to say when the tension members are laid left right left or right left right. The torque properties are even better when, in a load bearing member 12, in each case 1, 2 or 3 SZS laid tension members alternate with an identical number of ZSZ laid tension members and these are embedded in one plane next to one another in the load bearing member body 15. The total number of ZSZ laid and of SZS laid tension members should in this case be identical.

For steel wires with a mean modulus of elasticity of about 190 kN/mm² to about 210 kN/mm² for the wires having the largest wire diameter D in the tension member of a load bearing member, very good values for the service life, along with sufficient viability, have been obtained when the ratio of the pulley diameter D of the smallest pulley in the elevator system to the wire diameter δ of the thickest wire in the tension member lies in the range of D/δ=700 to 280, preferably in the range of D/δ=600 to 320.

As already mentioned above, tension members, such as are illustrated and explained by way of example in FIGS. 7 to 12, are used according to the invention in load bearing members 12 of an elevator system according to the invention. The bending stress σb in the thickest wire 43 having the largest wire diameter δ of the tension member 22 in the load bearing member 12 then lies, in the event of bending over a smallest bending radius r or around a smallest pulley of pulley diameter D in the elevator system, in the range of σb=300 N/mm² to 900 N/mm², preferably in the range of σb=450 N/mm² to 750 N/mm² and even better in the range of σb=490 N/mm² to 660 N/mm².

The particulars given above apply especially to the customary steel wire types, the E moduli of which lie between 140 kN/mm² and 230 kN/mm²; and particularly to wires made from stainless steels with E moduli of between 150 kN/mm² and 160 kN/mm² and from high strength alloyed steels with E moduli of between 160 kN/mm² and 230 kN/mm².

Load bearing members 12 with such tension members 22 may be configured as flat belts, as illustrated in FIGS. 3a and 3b. Such load bearing members 12 are preferably used in elevator systems 9 which are equipped with flat and/or cambered pulleys 4.1, 4.2, 4.3, 4.4 and which, if required, also have flanged pulleys for better guidance.

However, rope like load bearing members of circular cross section and with one or more sheathed tension members can also be configured expediently with these tension members 22 according to the invention. Elevator systems 9 equipped with such load bearing members 12 preferably have pulleys 4.1, 4.2, 4.3, 4.4 with semicircular to wedge like grooves along their circumference.

By means of a load bearing member 12 configured as a V ribbed belt, as is illustrated, for example, in FIGS. 2a and 2b, an elevator system 9 according to the invention, as illustrated in FIG. 1, will be explained in more detail below. The load bearing member 12 is guided with its traction side 18 over the driving pulley 4.1, the counterweight carrying pulley 4.3 and the guide pulleys 4.4, these being provided correspondingly on their periphery with grooves 35 which are formed complementarily to the ribs 20 of the load bearing member 12. Where the V ribbed belt 12 loops around one of the belt pulleys 4.1, 4.3 and 4.4, its ribs 20 lie in matching grooves 35 of the belt pulley, thus ensuring perfect guidance of the load bearing member 12 on these belt pulleys.

The V ribbed belt 12 is guided over the car carrying pulleys 4.2 with counter bending, that is to say the ribs 20 of the V ribbed belt 12, when it runs over these pulleys, are located on its rear side 17 which faces away from the car carrying pulleys 4.2 and which is designed here as the flat side. For better lateral guidance of the V ribbed belt 12, the car carrying pulleys 4,2 may have lateral flanged pulleys. Another possibility for guiding the load bearing member laterally is to arrange two guide pulleys 4.4 on the running path of the load bearing member 12 between the two car carrying pulleys 4.2, as is shown in this special example. As is clear from FIG. 1, the load bearing member 12 is guided between the car carrying pulleys 4.2 with its ribbed side over the guide pulleys 4.4 provided with corresponding grooves. The grooves of the guide pulleys 4.4 cooperate with the ribs of the V ribbed belt 12 for lateral guidance, so that the car carrying pulleys 4.2 do not require any flanged pulleys. This variant is advantageous since, in contrast to lateral guidance by means of flanged pulleys, it does not cause any lateral wear on the load bearing member 12. However, depending on the car dimensions the selected suspension ratio and the cooperation of the pulleys with the load bearing member, it is also possible to operate completely without guide pulleys 4,4 between the car carrying pulleys 4.2 or to provide only one or more than two guide pulleys 4.4 instead of the two guide pulleys 4.4 shown under the car 3. In general, it is also possible for the load bearing member to be guided (not illustrated) onto the other car side above the car instead of below the car.

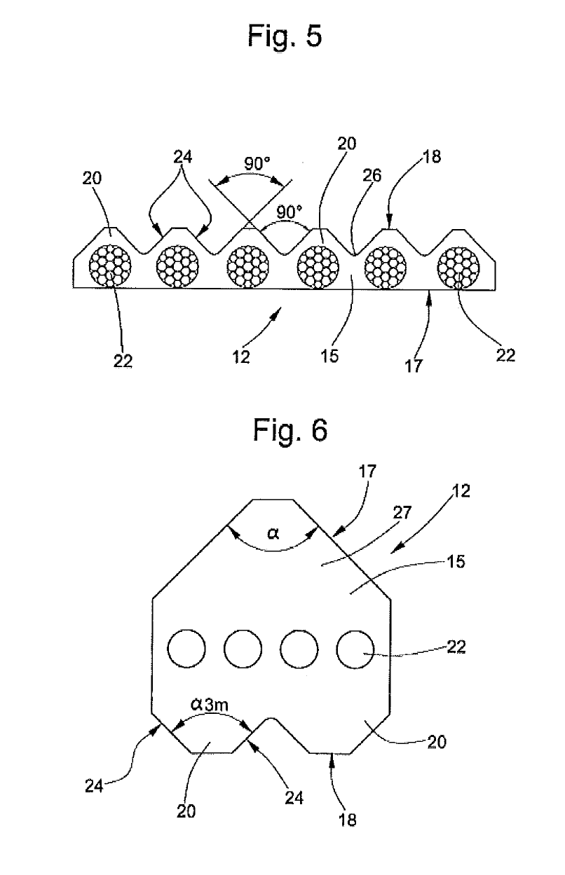

As shown by way of example in FIG. 4a, the driving pulley 4.1 not only has grooves 35 in its periphery, but, furthermore, in its grooves 35, a groove bottom 36 which lies lower than the tips, flattened trapezoidally in this example, of the engaging ribs 20 of the V ribbed belt 12. Thus, on the driving pulley 4.1, only flanks 24 of the ribs 20 of the V ribbed belt 12 cooperate with flanks 38 of the grooves 35 of the driving pulley 4.1, so as to give rise between the grooves 35 of the driving pulley 4.1 and the ribs 20 of the V ribbed belt 12 to a wedge effect which improves the traction capacity. Further, the wedge effect can be improved if the elevations 37 of the driving pulley 4.1 which lie between the grooves 35 of the driving pulley 4.1 and extend peripherally are designed to be somewhat less high than the depressions 26 between the ribs 20 of the load bearing member 12 are deep. Thus, when the depressions 26 and the elevations 38 impinge one onto the other, a cavity 28 is obtained. Consequently, forces take effect only via the flanks 24 of the ribs 20 and the flanks 38 of the grooves 35. The carrying pulleys 4.2, 4.3 and guide pulleys 4.4 advantageously have grooves 35 without a lower lying groove bottom 36 and elevations 38 which are dimensioned identically to the depressions 26 of the load bearing member 12 on its traction side 18. This reduces the risk that the load bearing member jams in the pulley 4.2, 4.3, 4.4 and ensures good guidance along with lower traction.

In the elevator system 9 according to the invention illustrated in FIG. 1, the diameters of all the belt pulleys are identical. It is also conceivable, however, that the belt pulleys are of different size and the carrying and/or deflecting pulleys 4.2, 4.3, 4.4 have a larger diameter than the driving pulley 4.1 or a smaller diameter than the driving pulley 4.1, or else that pulleys 4.2, 4.3 are provided, at which some pulleys 4.2, 4.3, 4.4 have a larger diameter and the others a smaller diameter than the driving pulley 4.1. According to the invention, the load bearing member 12 used in the elevator system is provided with tension members 22 which are manufactured from wires and which are in the form of a cord or rope. The wires in the tension member 22 may all have the same diameter or be of different thickness. According to the invention, the tension member is configured such that, when the tension member 22 runs over a smallest pulley with a smallest pulley diameter D in the elevator system, a bending stress σb in the thickest wire having the largest wire diameter δ of the tension member 22 is obtained, as a function of the modulus of elasticity E and of the diameter δ of the thickest wire, according to the following equation: σb=(δ*E)/D. The best ratio between the viability of the elevator system and the service life of the load bearing member 12 is in this case obtained with a tension member 22, of which the thickest wire having the largest diameter D has a bending stress do in a range of between σb=300 N/mm² and 900 N/mm².

FIG. 4a shows a cross section through a V ribbed belt 12 according to the present invention which comprises a belt body 15 and a plurality of tension members 22 embedded therein. The belt body 15 is produced from an elastic material, such as, for example, natural rubber or synthetic rubber, such as NBR, HNBR, ethylene propylene rubber (EPM), ethylene propylene diene rubber (EPDM), etc. Also, a multiplicity of synthetic elastomers, polyamide (PA), polyethylene (PE), polycarbonate (PC), polychloroprene (CR), polyurethane (PU) and, particularly on account of simpler processing, also thermoplastic elastomers, such as ether or ester based thermoplastic polyurethane (TPU).

The belt body 15 is provided on its flat side 17 with a covering layer 62 which here comprises an impregnated woven fabric. However, non impregnated woven fabrics 61 may also be applied or coatings may be provided by extrusion, adhesive bonding, lamination or flocking.

In the examples shown in FIGS. 2a, 2b and 4a, each rib 20 is assigned on the traction side 18 two tension members 22. For beneficial force transmission between the pulleys 4 in the elevator system and the tension members 22 in the load bearing member 12, the tension members 22 are in each case arranged centrally above the vertical projection 70 of a flank 24 of the rib 20 (FIG. 2b).

If each rib 20 of the load bearing member 12 designed as a V ribbed belt is assigned two tension members 22 which are arranged centrally above a flank 24 of the rib 20, they can jointly transmit optimally the belt loads occurring with regard to each rib in the V ribbed belt. These belt loads, on the one hand, involve the transmission of straightforward tensile forces in the belt longitudinal direction. On the other hand, when the tension members 22 are looped around a belt pulley 4.1-4.4, forces are transmitted in the radial direction via the belt body 15 to the belt pulley 4.1, 4.2, 4.3, 4.4. The cross sections of the tension members 22 are dimensioned such that these radial forces do not intersect the belt body 15. When looping around a belt pulley, bending stresses additionally arise in the tension members 22 as a result of the curvature of the load bearing member 12 lying on the belt pulley. In order to keep these bending stresses in the tension members 22 as low as possible, the forces to be transmitted per rib 20 are distributed to a plurality of tension members and especially beneficially to two tension members, as illustrated in FIGS. 2a, 2b and 4a.

As shown in the exemplary embodiment in FIG. 4b, however, it is also possible to provide more than two tension members 22 per rib 20. FIG. 4b shows three tension members 22 per rib 20, the ribs 20 being configured trapezoidally, as seen in cross section. The in each case middle tension member is arranged centrally in the rib 20, and the two tension members framing it in the rib are preferably again arranged centrally above a flank 24. However, the latter is not mandatory. In addition to the number of three tension members which is shown here, four or five tension members per rib may also be envisaged, cross sectional shapes of the ribs, as illustrated in FIG. 2b, also being conceivable. Preferably, the spacing X between a tension member and the traction side surface of the load bearing member or, in other words, the traction side overlap X of the tension member by the polymer material of the body 15 corresponds to about 20% of the overall thickness s of the load bearing member 12.

In contrast to the examples in FIGS. 2a, 2b and 4a, the load bearing member 12 in FIG. 4b is not provided with a coating on its flat side 17. However, instead, it has on its traction side 18 a coating 62, indicated by a dashed line, with the aid of which the coefficient of friction and/or the wear in interaction with the driving pulley 4.1 and/or with another belt pulley 4.2, 4.3, 4.4 of the elevator system 9 are/is set. This coating 62, too, preferably comprises a woven fabric 61, in particular a nylon fabric.

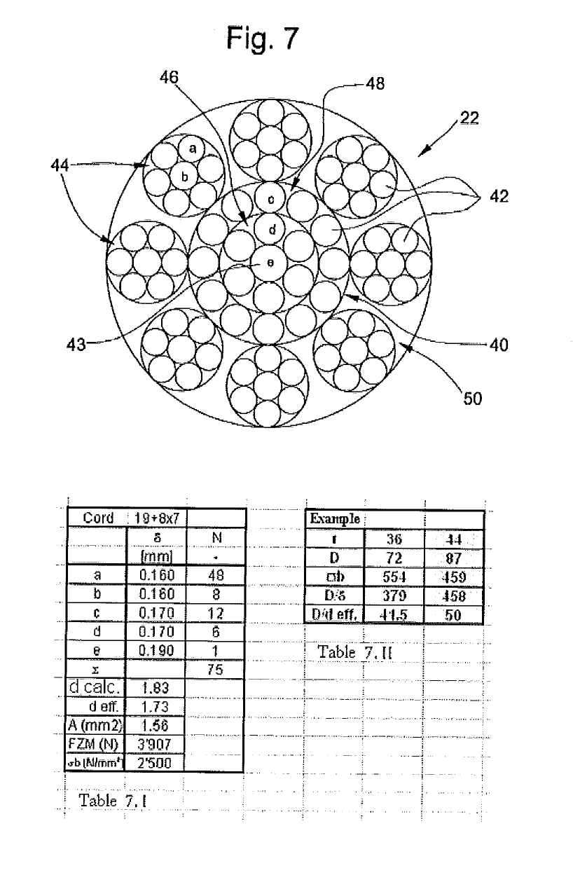

FIG. 5 illustrates a further embodiment of a load bearing member 12 according to the invention. As can be seen clearly in FIG. 5, in this example the load bearing member 12 has only one tension member 22 per rib 20 on the traction side 18. With identical dimensioning of the load bearing member 12 and of its ribs 20, when there is only one tension member 22 per rib 20, instead of two tension members per rib 20, the tension members 22 can have a larger diameter. Larger diameters of the tension members 22 make it possible to use more wires or else thicker wires. If the strength of the wires is the same, both of these increase the carrying force of the tension members 22, and moreover the latter simplifies stranding and lowers the costs per tension member 22. The tension members 22 are preferably arranged in each case centrally in their rib 20, and this leads to highly uniform distribution of the tension member load via the two flanks 24 of each rib 20. Moreover, the overall thickness of the load bearing member can be kept somewhat smaller.

As in the examples from FIGS. 2a, 2b and 4b, the load bearing member example 12 from FIG. 5 likewise has on its flat rear side 17 a coating which in this example contains tetrafluoroethylene in order to reduce the coefficients of friction upon cooperation with deflecting pulleys 4.4 or carrying pulleys 4.2, 4.3. The layer may contain as a diffusion layer polytetrafluoroethylene particles in the sheathing material or may be provided as a film-like polymer-based or fabric-based covering with polytetrafluoroethylene particles. The tetrafluoroethylene particles in this case preferably have a particle size of 10 to 30 micrometers.

It is applicable to all the coatings mentioned that they can be applied over the entire length of the load bearing member 12 or only over one or more specific portions of length of the load bearing member 12. In particular, those portions of length of the load bearing member 12 can be coated which cooperate with the driving pulley when the car 3 or counterweight 8 sits, for example, on a buffer in the shaft pit.

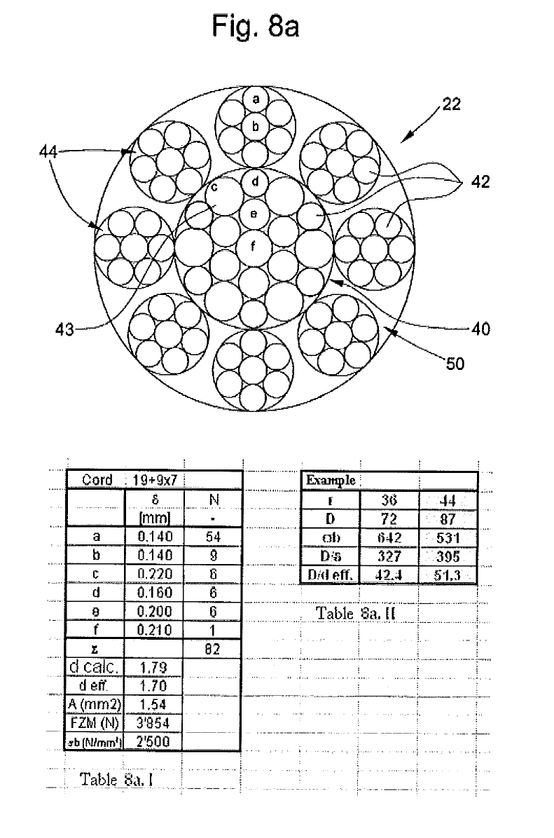

FIG. 6 shows a load bearing member 12 which likewise has on its traction side 18 ribs 20 in each case with two tension members 22. What is particular to this load bearing member 12 is that it has exactly two ribs 20 on its traction side 18 and a guide rib 19 additionally on its rear side 17. The guide rib 19 cooperates during counter bending with deflecting, guide and carrying pulleys 4.2, 4.3, 4.4 which have a corresponding guide groove in order to receive the guide rib 19 (not illustrated explicitly). The load bearing member from FIG. 6 is higher than it is wide or is at most as high as it is wide. In a further embodiment, this load bearing member may also be equipped with only one tension member 22 per rib or with more than two tension members per rib, in particular with 3, 4 or 5 tension members per rib. As in the other embodiments, it may also be provided on the traction side and/or on the rear side with a coating. Conversely, the other embodiments of the load bearing member 12 which are shown here may also be provided with one or more guide ribs 19 on the rear side 17. These may be of the same size or larger than the ribs 20 on the traction side 18 and, for better stability of the load bearing member 12, may be manufactured from another material or contain stabilizing elements (not illustrated) which extend over the length of the load bearing member 12 and are similar to the tension members 22.

As illustrated in FIGS. 4b and 5, the load bearing members 12 have a flank angle β of about 90°. The angle formed by the two flanks 24 of a rib 20 of the load bearing member 12 is designated as the flank angle β. Tests have shown that the flank angle β has a decisive influence on the generation of noise and the occurrence of vibrations, and that flank angles β of 81° to 120° and preferably of 83° to 105° and, even better, of 85° to 95° can be used for a V-ribbed belt provided as an elevator load bearing member. The best properties in this regard and also as regards guidance are achieved with rib angles β of 90°.

Load bearing members, the flank angle 6 of which in the ribs 20 is identical to the angles in the depressions 26, can be produced especially simply. The same also applies to the production of grooved belt pulleys which are equipped, to match with the load bearing members provided, with grooves 35 and elevations 37, the flanks 38 of which in the groove 35 and in the elevation 37 form in each case a flank angle β′.

Moreover, it can be seen from FIGS. 4b and 5 that small dimensions and a low weight of a ribbed load bearing member 12 are achieved in that the spacings X between the outer contours of the tension members 12 and the surfaces/flanks of the ribs 20 are designed to be as small as possible. Tests of ribbed load bearing members 12 have afforded optimal properties in which these spacings X amount at most to 20% of the overall thickness s of the load bearing member. The overall thickness s is to be understood as being the overall thickness of the belt body 15 including the ribs 20.

The mutual dependencies can be illustrated mathematically in simplified form. The bending stress σb is then obtained according to the following equation: σb=(δ*E)/2r. The smallest bending radius r provided is obtained, in consultation with the elevator builder, from the diameter D of the smallest pulley provided in the elevator system as: r=D/2.

The bending stress σb of the thickest wire in a tension member of an elevator load bearing member is obtained approximately as a function of the smallest pulley diameter D via which the load bearing member is guided, of the modulus of elasticity E (also referred to briefly as E modulus) of the thickest wire and of its wire diameter δ according to the following equation: σb=(δ*E)/D. With this relationship being taken into account, the composition of the elevator, with its possibly different pulley diameters, and the load bearing member, with its at least one tension member and with its sheathing, can be coordinated with one another.

If the bending stress σb which, when the load bearing member runs over a pulley having the smallest pulley diameter D, is induced in the wire of the tension member which has the largest wire diameter, is selected in the range of between 300 N/mm² to 750 N/mm², the service life of the tension member is increased. The best results with regard to service life and viability are achieved with load bearing members, the tension members of which, when the load bearing member runs over a pulley having the smallest pulley dimension D, experience in their thickest wires a bending stress σb in the range of σb=350 N/mm² to 650 N/mm².

As already noted further above, in order to obtain an elevator system having low maintenance costs, it is important, inter alia, to use a load bearing member having a long service life in the system. Moreover, the costs can be reduced if a small lightweight motor with a small driving pulley can be used. The space required for an elevator system can be reduced further if, in addition to the small driving pulley, further pulleys having small diameters are employed. It is likewise advantageous for an elevator system to have traction between driving pulley and load bearing member which is adapted well to the defined requirements of this system.

In accordance with the provisions of the patent statutes, the present invention has been described in what is considered to represent its preferred embodiment. However, it should be noted that the invention can be practiced otherwise than as specifically illustrated and described without departing from its spirit or scope.

1-23. (canceled)

24. An elevator system having a drive unit with a driving pulley guiding and driving a load bearing member which moves an elevator car, the load bearing member comprising:
a body formed from a polymer material; and
at least one tension member embedded into the body and extending in a longitudinal direction of the load bearing member, the tension member being formed from a plurality of wires of at least two different diameters as a cord or rope, and a thickest one of the wires with a largest wire diameter δ having a bending stress σb in at least one of a first bending stress range of between 350 N/mm² and 900 N/mm², a second bending stress range of between 450 N/mm² and 750 N/mm², and a third bending stress range of between 490 N/mm² and 660 N/mm² when the tension member runs over a smallest pulley with a smallest pulley diameter D in the elevator system.

25. The elevator system according to claim 24 wherein the bending stress is a function of a modulus of elasticity E and the diameter of the thickest wire of the tension member according to an equation σb=(δ*E)/D.

26. The elevator system according to claim 24 wherein the thickest wire has a modulus of elasticity of about 210,000 N/mm², and a ratio of the pulley diameter of the smallest pulley to the wire diameter of the thickest wire lies in at least one of a first ratio range of 200 to 650 and a second ratio range of 230 to 500.

27. The elevator system according to claim 24 wherein the driving pulley is the smallest pulley with the smallest pulley diameter.

28. The elevator system according to claim 24 wherein the load bearing member has, at least on a traction side facing the driving pulley, a plurality of ribs running parallel in the longitudinal direction of the load bearing member and at least two of the tension member extending in the longitudinal direction of the load bearing member, the tension members being arranged in a plane next to one another and spaced apart from one another extending in a width of the load bearing member, and wherein the driving pulley has formed in a periphery a plurality of grooves running in a circumferential direction and each of the grooves cooperating with one of the ribs of the load bearing member, the grooves being provided with a lower-lying groove bottom, so that a wedge effect is obtained when the grooves cooperate with the ribs.

29. The elevator system according to claim 28 wherein the grooves of the driving pulley have a wedge-shaped, triangular or trapezoidal cross section with a flank angle being at least one of in a first angle range of 81° to 120°, in a second angle range of 83° to 105°, in a third angle range of 85° to 95°, and an angle of 90°.

30. A load bearing member for at least one of carrying and moving an elevator car in an elevator system, the load bearing member being guidable and drivable by a driving pulley of a drive unit of the elevator system, the load bearing member having a body formed from a polymer material and at least one tension member embedded into the body and extending in a longitudinal direction of the load bearing member, the at least one tension member including a plurality of wires of at least two different diameters forming a cord or a rope, and a thickest one of the wires with a largest wire diameter δ having, during bending of the tension member over a pulley having a smallest bending radius r, a bending stress σb in at least one of a first bending stress range of between 350 N/mm² and 900 N/mm², a second bending stress range of between 450 N/mm² and 750 N/mm², and a third bending stress range of 490 N/mm² to 660 N/mm², the bending stress being a function of a modulus of elasticity E and of the diameter δ of the thickest wire corresponding to an equation σb=(δ*E)/2r.

31. The load bearing member according to claim 30 wherein the modulus of elasticity of the thickest wire is about 210,000 N/mm², and a ratio of the smallest bending radius to the largest wire diameter of the thickest wire in the tension member lies in at least one of a first ratio range of 200 to 650 and a second ratio range of 240 to 500.

32. The load bearing member according to claim 30 wherein at least ones of the wires in an outer wire ply and cords formed from the wires in an outer cord ply are spaced apart from one another by at least 0.03 mm.

33. The load bearing member according to claims 30 wherein the tension member has a wire configuration (1f−6e−6c+6d)W+n*(1b+6a), “n” being a whole number between 5 and 10 and the smallest bending radius being ≧30 mm.

34. The load bearing member according to claim 30 wherein the tension member has a wire configuration (3d+7c)+n*(3b+8a), “n” being a whole number between 5 and 10 and the smallest bending radius being ≧32 mm.

35. The load bearing member according to claim 30 wherein the tension member has a wire configuration (3f−3e+6d)W+n*(3c−3b+6a)W, “n” being a whole number between 5 and 10 and the smallest bending radius being ≧30 mm.

36. The load bearing member according to claim 30 wherein the tension member has a wire configuration (1e−6d+12c)+n*(1b+6a)W, “n” being a whole number between 5 and 10 and the smallest bending radius being ≧32 mm.

37. The load bearing member according to claim 30 wherein the tension member is SZS or ZSZ laid.

38. The load bearing member according to claim 30 wherein the tension member is formed as a cord in a seal configuration with a core composed of three wires with a diameter “a” and with two wire plies surrounding the core and having wires with different diameters “b” and “c” in a configuration (3a+9b+15c), and wherein the smallest bending radius is ≧32 mm.

39. The load bearing member according to claim 30 having a traction side with a plurality of ribs running parallel in the longitudinal direction of the load bearing member and at least two of the tension member extending in the longitudinal direction of the load bearing member, the at least two tension members being arranged in a plane next to one another and spaced apart from one another in a direction of a width of the load bearing member.

40. The load bearing member according to claim 39 wherein the ribs have a wedge-shaped, triangular or trapezoidal cross section with two flanks which run toward one another and form a flank angle which is at least one of in a first angle range of 81° to 120°, a second angle range of 83° to 105°, a third angle range of 85° to 95°, and an angle of 90°±1°.

41. The load bearing member according to claim 39 wherein each of the ribs is associated with two of the tension member that are arranged in a region of a vertical projection of a flank of the rib.

42. The load bearing member according to claim 39 wherein each of the ribs is associated with one of the tension member that is arranged centrally with respect to two flanks of the rib.

43. The load bearing member according to claim 39 wherein at least one of the traction side of the load bearing member and a rear side, lying opposite the traction side, of the load bearing member is coated, to set a desired coefficient of friction between the coated side and the driving pulley, the coating being a woven fabric composed of at least one of natural fibers and synthetic fibers.

44. The load bearing member according to claim 30 wherein the load bearing member has two ribs on the traction side and a guide rib on a rear side opposite the traction side.
